(19) United States
(12) Patent Application Publication
(10) Pub. No.: US 2024/0054166 A1
(43) Pub. Date: Feb. 15, 2024

(54) SYSTEM AND METHOD FOR SUBMITTING, COLLATING, COLLABORATING, MODIFYING, STORING AND PUBLISHING TEXT, AUDIO, PHOTO AND VIDEO TRIBUTES

(71) Applicant: Isibor Arhuidese, Tampa, FL (US)

(72) Inventor: Isibor Arhuidese, Tampa, FL (US)

(21) Appl. No.: 17/887,474

(22) Filed: Aug. 14, 2022

(51) Int. Cl. G06F 16/9536; G06F 16/906; G06F 16/954

(52) U.S. Cl. CPC G06F 16/9536; G06F 16/906; G06F 16/954

(57) ABSTRACT

The goal of this system is to provide a platform that allows individuals to obtain, store, edit and publish text, audio, photo and video about their encounter with an entity. The output may be disseminated as a tribute or feedback to the entity using computer, mobile phone internet or social media based outlets.

### BACKGROUND OF THE INVENTION

The invention pertains to electronic based systems and methods for documenting and publishing a tribute to a person, place or time; object, plant, animal, event or concept. Interactions between humans and other persons, animate and inanimate objects (including plants and animals), places, events, concepts and times, herein collectively referred to as the “entity” constitute an ever present component of the human experience. The interactions may be significant and worthy of documentation in real time. The encounters may also leave an impression on the person experiencing it worthy of recollection and documentation in retrospect. The real time experience or memory of the entity may be documented via text, audio, photo or video. The text, audio, photo or video content are herein collectively termed “media”. When multiple persons experience the same or similar entity, they may document their encounter or memory of it individually or collectively. The individual or collective impressions can be collated, customized, stored and published as a tribute or feedback to the entity. The stored or published tribute may be retrieved, replayed and shared in memory of the entity via mobile phone, computer, internet or social media platforms. The process of collating, customizing, storing and publishing the experience or impression is herein collectively termed the “project”.

The project output may serve as a tribute during life events such as birth, death, marriage, divorce or other anniversary or relationship events. The project and output may also be used for events related to education, work and community such as: graduation, promotion, transfers, retirements, residence, sports, religion, culture, entertainment, commerce or history of same. The project output may also be published as feedback to an entity for goods or services provided by the entity.

### SUMMARY OF THE INVENTION

This invention describes a system for acquisition, collation, modification, storage, collaboration and dissemination of text, audio, photo and video tributes by an individual or plurality of persons.

The initial aspect of the invention involves identifying the need for a tribute and initiation of the project. The purpose of the project is specified and documented. A person or plurality of persons intended to contribute to the project are identified as collaborators. The collaborators are invited via text, photo, audio or video messages disseminated via mobile phones, computer, internet links, electronic mail, social media based messages, machine readable quick response or bar codes. The purpose, desired media and goal of the project are shared with the collaborators.

The next aspect of the system relates to acquisition of the desired media. The desired text, audio, photo or video media may be captured in real time or as a memory of the entity using mobile phones, computers, audio, photo or video recorders or cameras and scanning machines in traditional, portable, wearable or miniaturized formats. The collaborators acquire the media using any of the aforementioned media capturing devices. The acquired media may be temporarily stored on the acquisition device or transmitted for central collation as described in the subsequent aspects.

Another aspect of the invention pertains to the collation of the acquired media. The text, audio, photo or video media obtained in the preceding aspect of the project are transmitted electronically to a central collation unit. The portal for collation may be a computer or mobile phone based website, web link, application (app) or electronic mail attachment. The mode of collation may be included in the invitation to collaborators.

In another aspect, the collated text, audio, photo and video are stored, sorted and edited to achieve harmony about the entity in focus. The media may be stored in a computer or cloud based system. The stored media may then be sorted according to categories and edited by an individual or plurality or persons. Editing may focus on elements such as achieving a smooth transition between the individual media submissions, labelling, juxtaposition of media components and harmony with regards to the central theme of the project.

Another aspect of the present invention provides a system for disseminating the harmonized media content. This includes distribution of the final product to the collaborators or other persons. The final content may be published as text, photo, audio or video tributes through mobile phone, computer, internet or social media based messages, web links, websites, electronic mails, machine readable quick response or bar codes.

A more comprehensive understanding of the invention may be gained through the detailed description and accompanying drawings.

### BRIEF DESCRIPTION OF DRAWINGS

FIG. 1A illustrates a person interacting with an entity as exemplified by another person

FIG. 1B illustrates a person interacting with an entity as exemplified by an animal

FIG. 1C illustrates a person interacting with an entity as exemplified by a place

FIG. 1D illustrates a person interacting with an entity as exemplified by an object

FIG. 1E illustrates a person interacting with an entity as exemplified by an event

FIG. 2A illustrates a plurality of persons interacting with an entity as exemplified by another person

FIG. 2B illustrates a plurality of persons interacting with an entity as exemplified by an animal

FIG. 2C illustrates a plurality of persons interacting with an entity as exemplified by a place

FIG. 2D illustrates a plurality of persons interacting with an entity as exemplified by an object

FIG. 2E illustrates a plurality of persons interacting with an entity as exemplified by an event

FIG. 3A illustrates a person recalling a memory of an entity exemplified by another person

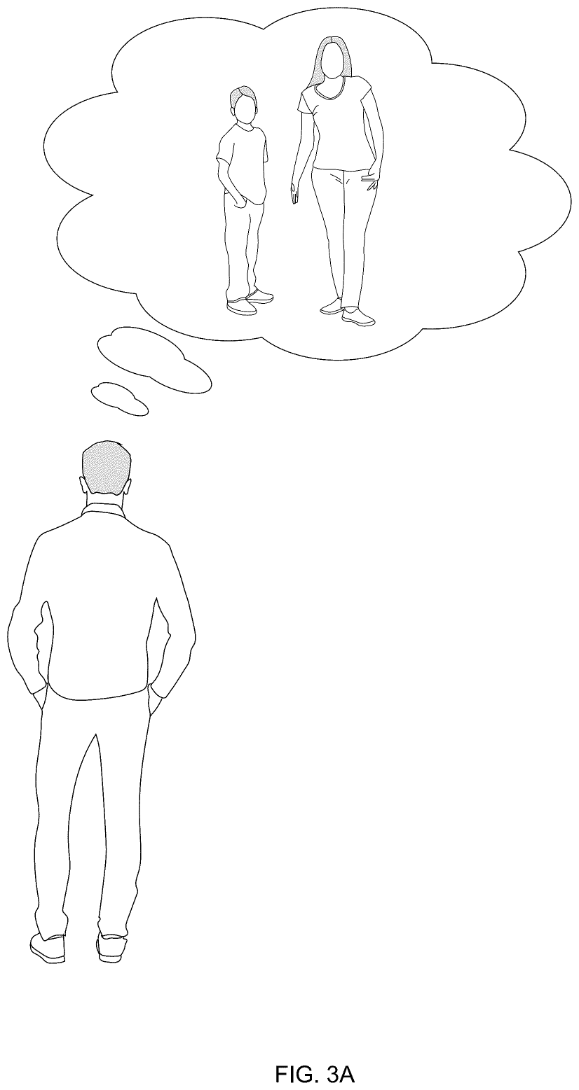

FIG. 3B illustrates a plurality of person recalling a memory of an entity exemplified by an event

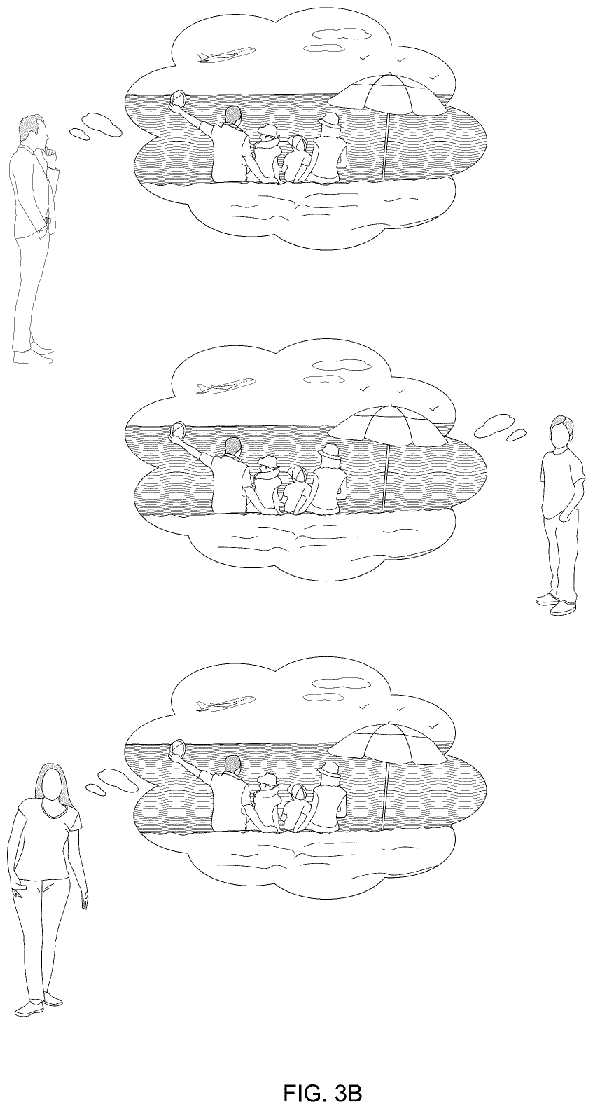

FIG. 4A illustrates the process of entering text into a desktop computer

FIG. 4B illustrates the process of entering text into a laptop computer

FIG. 4C illustrates the process of entering text into a computer tablet

FIG. 4D illustrates the process of entering text into a mobile phone device

FIG. 5A illustrates the process of obtaining audio using an audio recording device

FIG. 5B illustrates the process of obtaining audio using a mobile phone

FIG. 6A illustrates the process of obtaining pictures using a photo camera

FIG. 6B illustrates the process of obtaining pictures using a mobile phone

FIG. 7A illustrates the process of obtaining videos, motion pictures and accompanying audio using a video camera

FIG. 7B illustrates the process of obtaining videos, motion pictures and accompanying audio using a mobile phone

FIG. 8A illustrates the process of obtaining an electronic photograph or document from an existing paper photograph or document using a scanning machine or device

FIG. 8B illustrates the process of obtaining an electronic photograph or document from an existing paper photograph or document using a mobile phone or camera

FIG. 9A illustrates the process of transmitting text, audio, photo and video data obtained from text, audio, photo or video recording device to a computer or mobile phone. The data is thereafter transmitted or uploaded to a computer or cloud based server for storage and onward processing

FIG. 9B illustrates the process of documenting text, audio, photo and video data recollected from memory unto a text, audio, photo or video recording device; and subsequently transmitted to a computer or mobile phone. The data is thereafter transmitted or uploaded to a computer or cloud based server for storage and onward processing.

FIG. 10 illustrates the process of downloading text, audio, photo and video data from the computer or cloud based server to a computer or mobile phone device for editing.

FIG. 11 illustrates the process of disseminating curated media: text and audiovisual content to collaborators and other users through computer, mobile phone, internet or social media based platforms

### DETAILED DESCRIPTION OF THE INVENTION

As it pertains to this description of the invention, the term “entity” refers to the person, place, animal, plant, object, event, experience or time to which the tribute is being made. The term “media” refers to text, audio, photo or video content obtained by an individual or plurality of individuals for the purpose of creating a tribute to an entity.

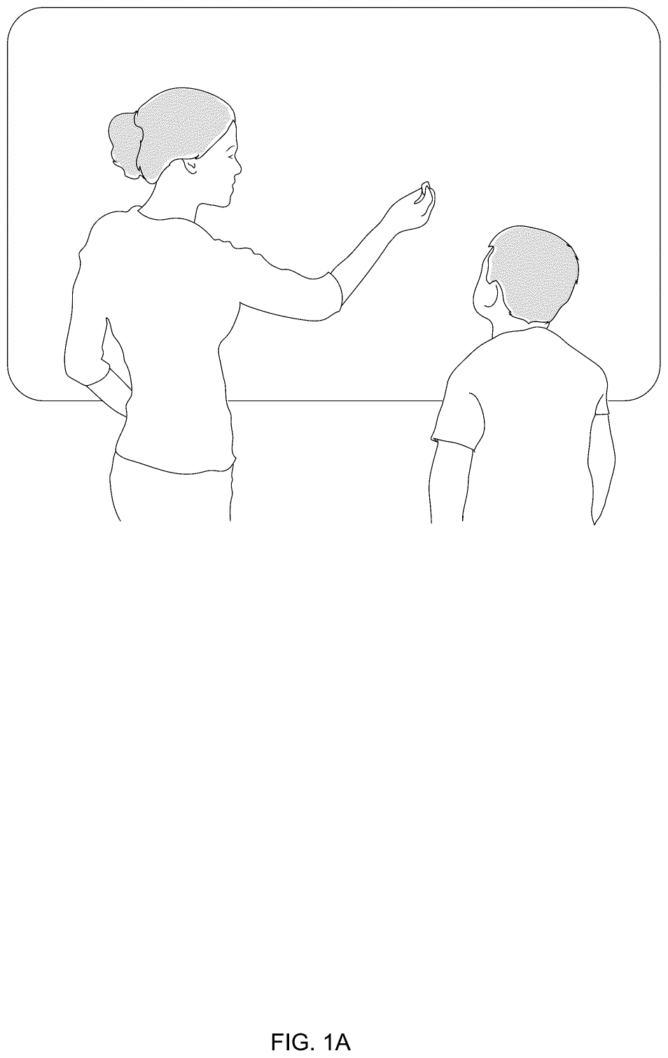

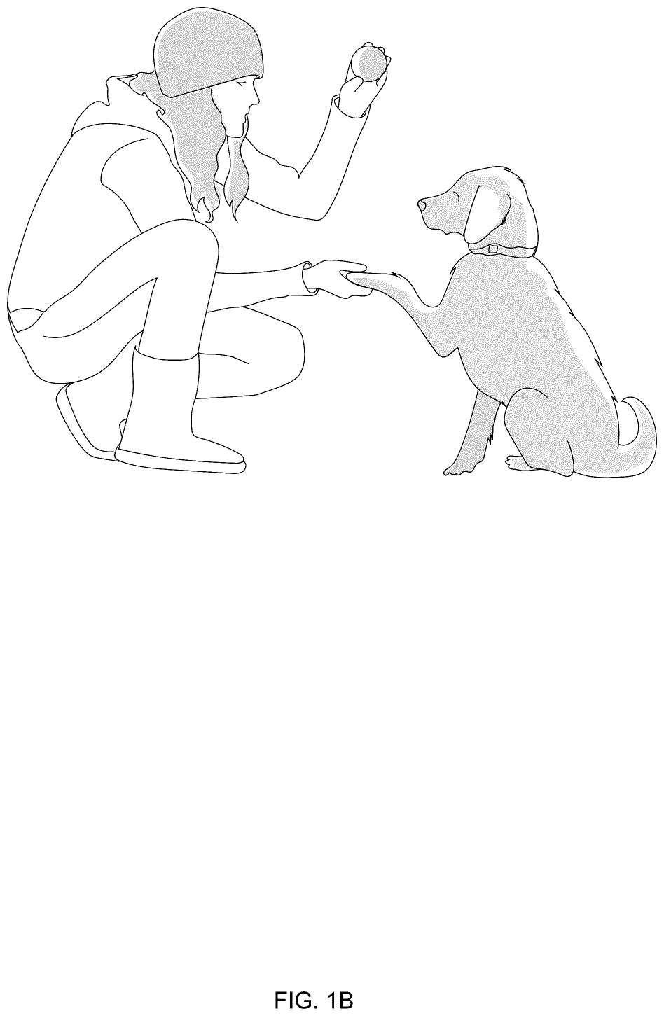

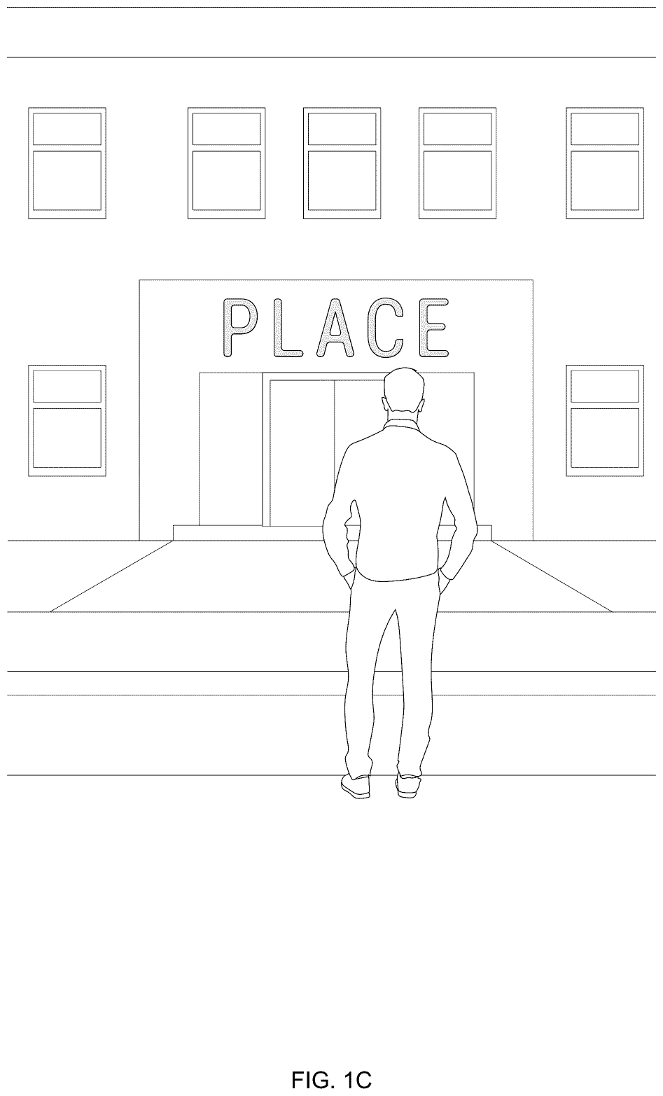

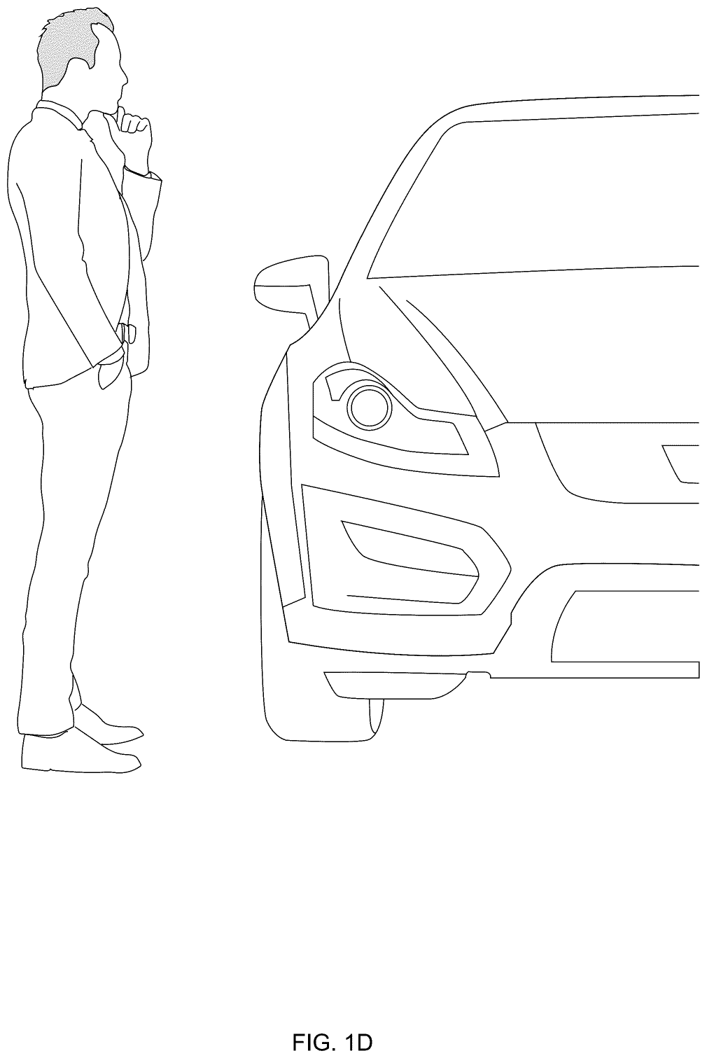

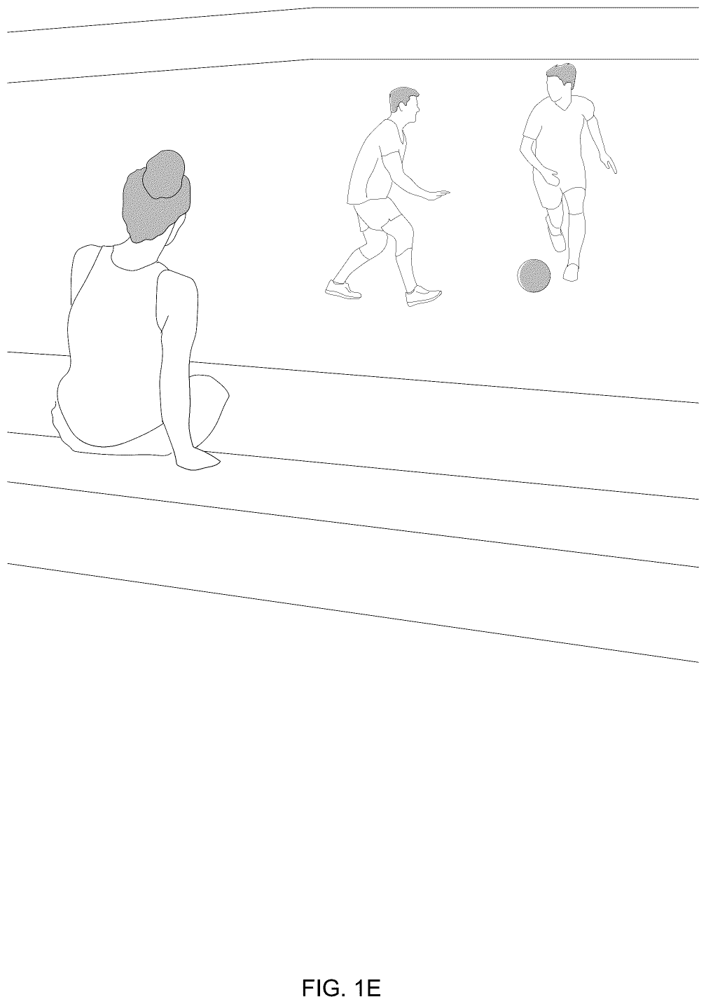

FIG. 1A-E depict an individual (number) interacting with various entities e.g another person (number), an animal (number), place (number), object (number), or event (number).

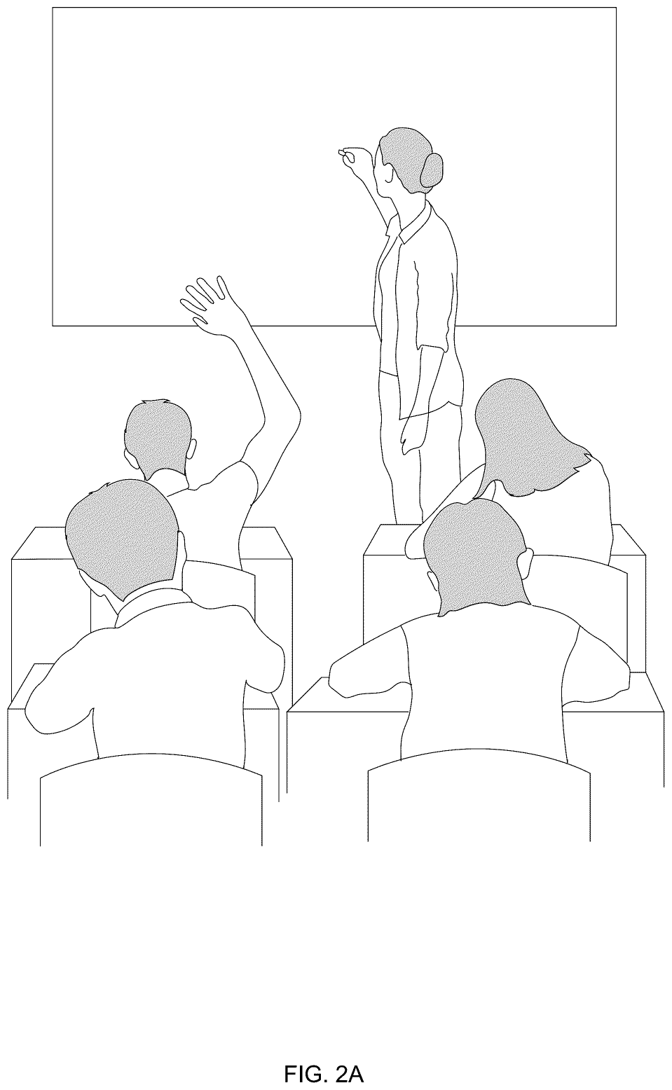

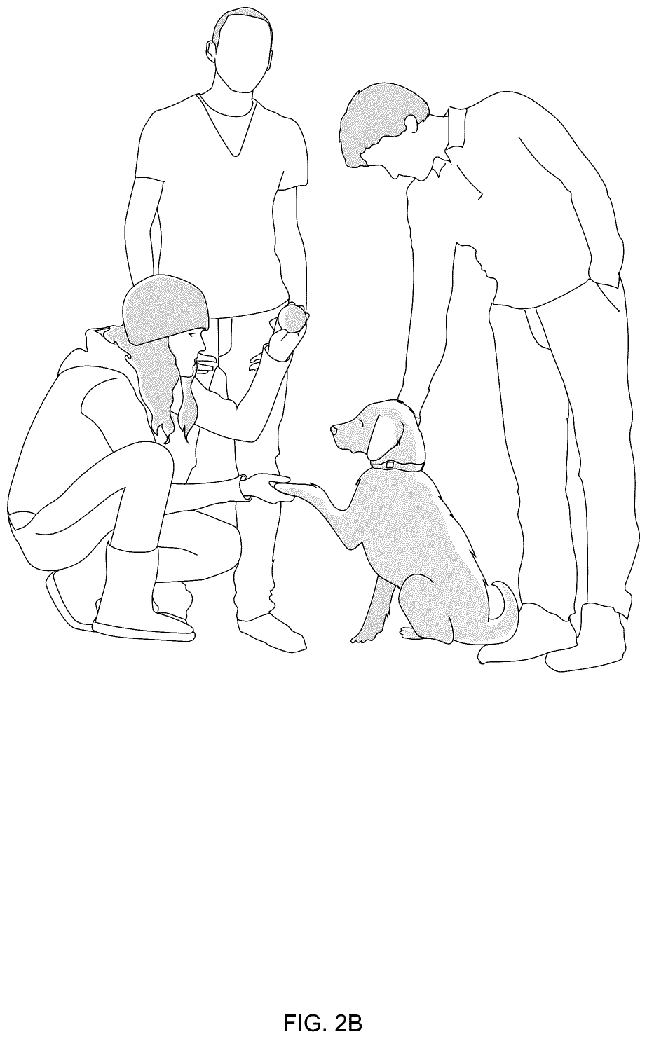

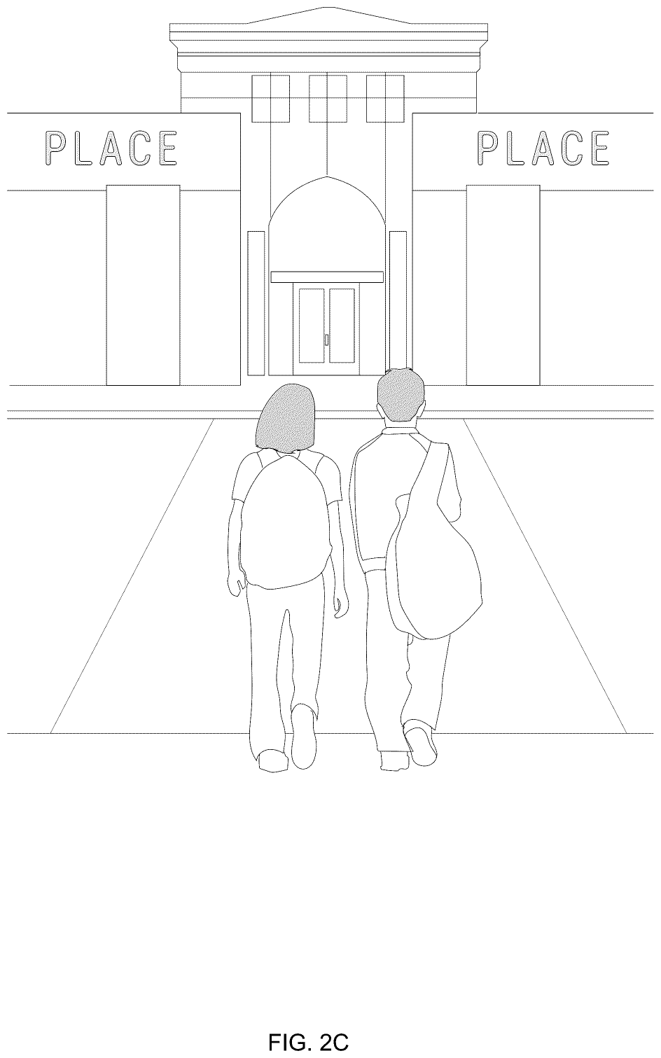

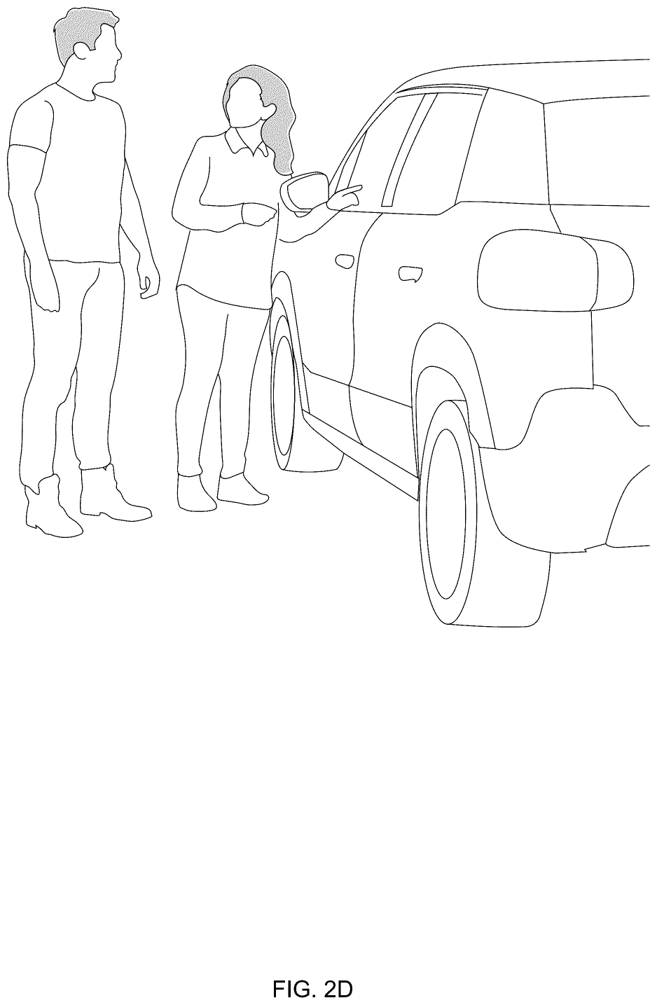

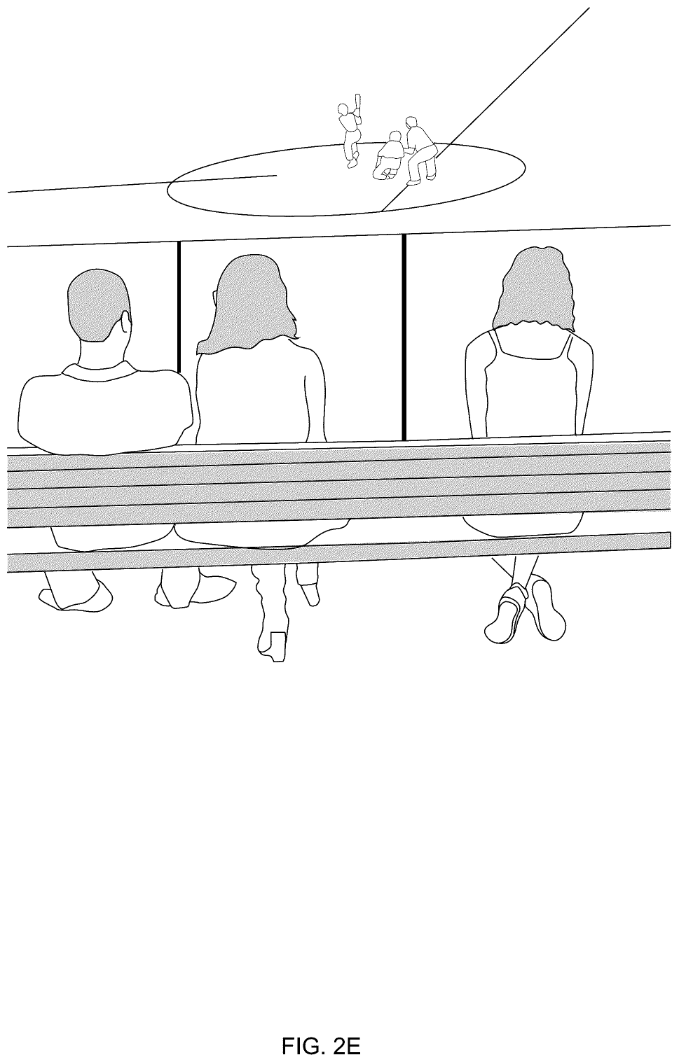

FIG. 2A-E depict a plurality of individuals (numbers) interacting with various entities e.g another person (number), an animal (number), place (number), object (number), or event (number).

During or after interaction with an entity, an individual or plurality of individuals may conceive the need to generate a tribute to the entity. The elements of the tribute “media” may be generated in real time or retrospectively. Figure X depicts an individual documenting an ongoing interaction with an entity. Figure X depicts an individual recalling a memory of an interaction with an entity. This invention describes the system and method for submitting, collating, collaborating, modifying, storing and publishing text, audio, photo and video tributes or feedback to persons, objects, place or time.

The tribute is launched by an individual or plurality or persons herein termed the initiator(s). Using a computer, internet, mobile phone, website or application based interface. The initiator specifies the entity for which the tribute is to be made and the goal of the tribute. Characteristics of the elements of the tribute such as type of media, number or size of media are also specified. The initiator(s) may identify other persons who can contribute to the tribute; herein termed collaborators. The collaborators may be invited on the basis of experience, knowledge or interest in the entity. The initiator may self-designate or identify another individual to serve as administrator for the tribute.

The invitation to collaborate or administer the tribute may take the form of text, audio, photo or video messages distributed via internet web based links, mobile phone or electronic mail messages, social media platforms, machine readable quick response or bar codes. The invitation to the collaborators may specify the characteristics of the tribute such as the entity, goal of the project, type, number or size of desired media. The initiator may also specify the number of collaborators and enable collaborators to invite other potential collaborators. The invited administrator or collaborator may decide to opt in or out of the collaboration or suggest a modification to the tribute. The initiator may be notified of the administrator or collaborators acceptance, denial or suggested modification.

Through the invitation, the collaborators are directed to the collaboration portal using their phone number, email address or internet web based link. The collaboration portal may exist as a website or computer, mobile phone or social media based application. Through the portal, the administrator may enforce the execution of the tribute through reminders to collaborators, approval of submitted content or approval of the final product at the completion of the project.

The media may be acquired by the initiator and collaborators using media acquisition devices such as computers in desktop, laptop or table configurations, mobile phones, audio recorders, cameras, photo or document scanners, video recorders in traditional, portable, wearable or miniaturized formats. The media can be text, audio, photo or video documentation of the encounter with the entity or a recollection of the experience or memory of the entity.

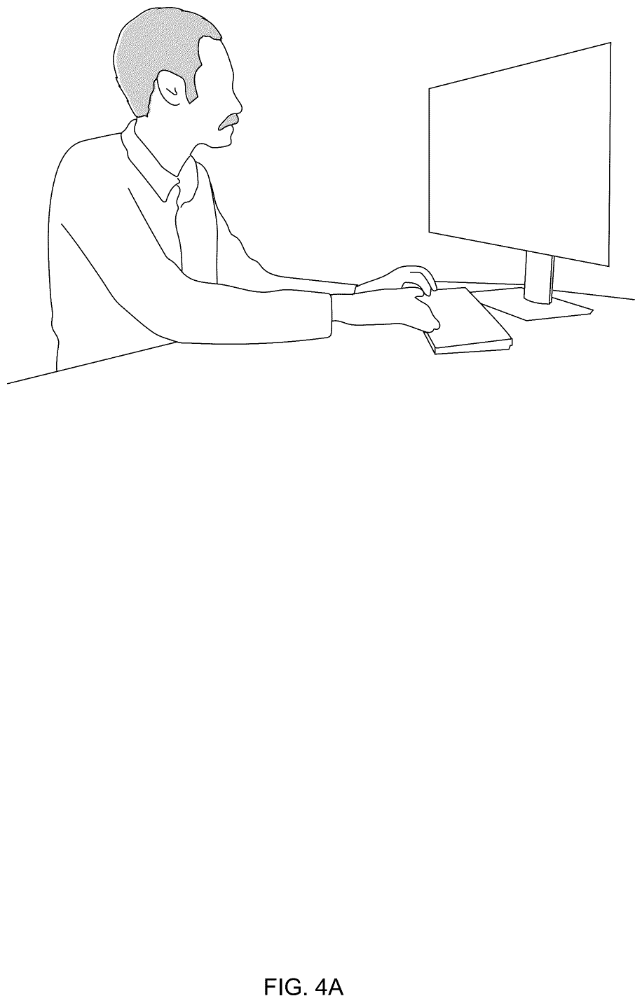

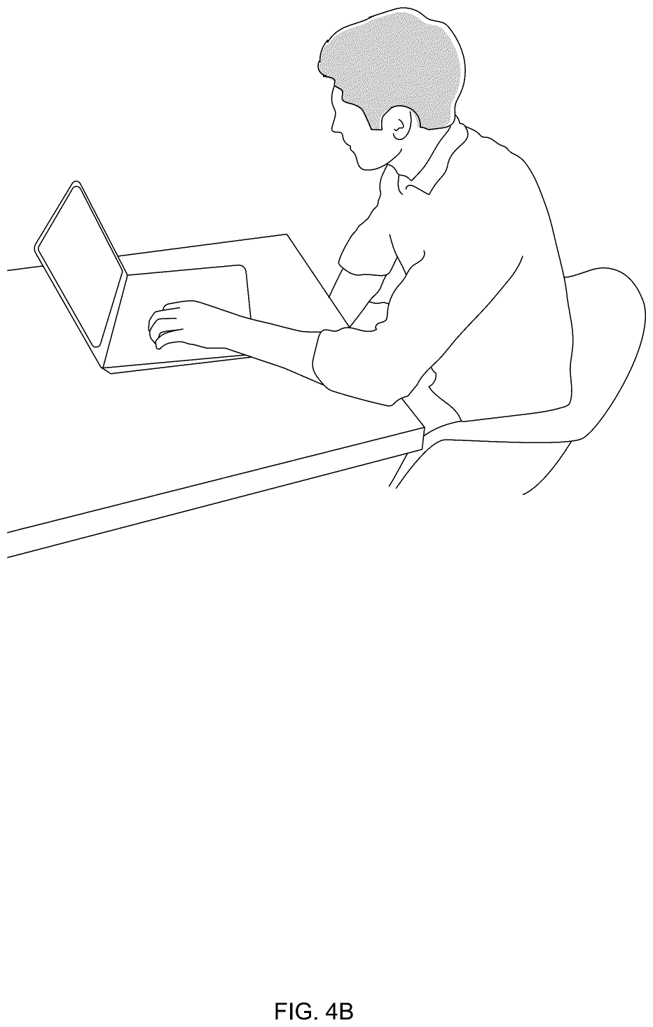

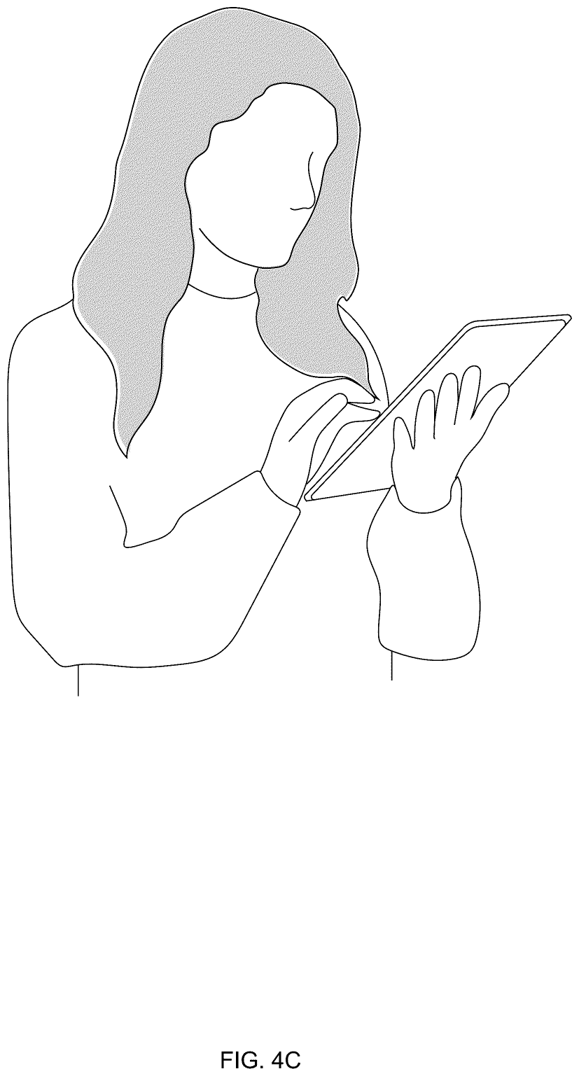

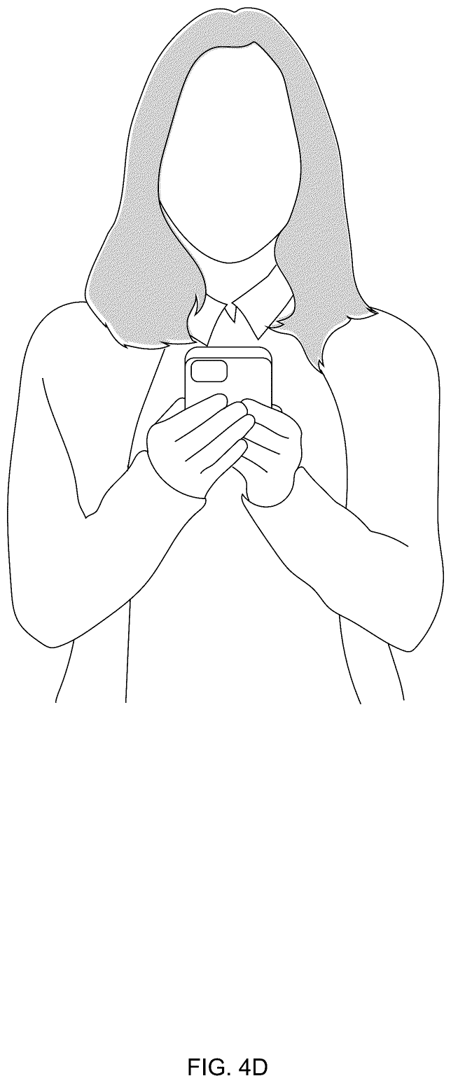

FIGS. 4A-D depicts a collaborator documenting text element of a tribute to an entity using a mobile phone FIG. 4A, computer in the desk top FIG. 4B, laptop FIG. 4C or tablet FIG. 4D

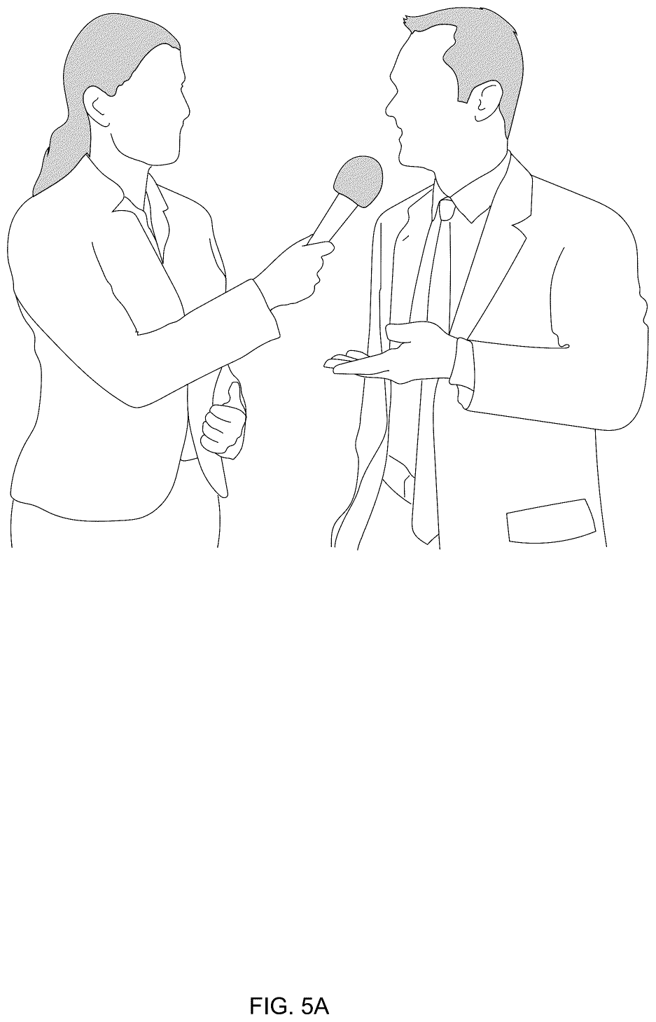

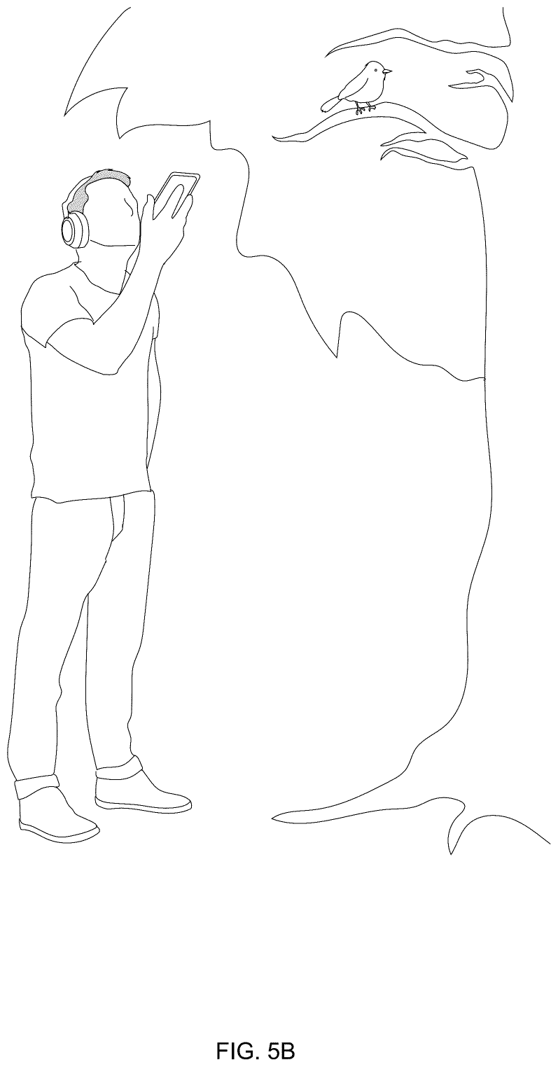

FIGS. 5A&B depict a collaborator acquiring audio media component of a tribute to an entity using an audio recording device FIG. 5A and mobile phone FIG. 5B.

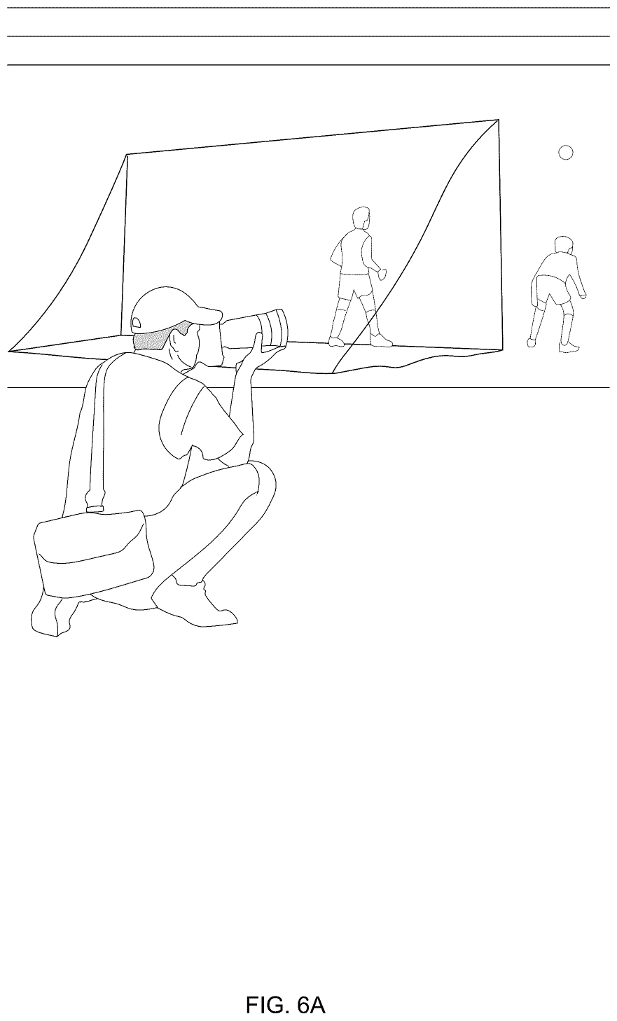

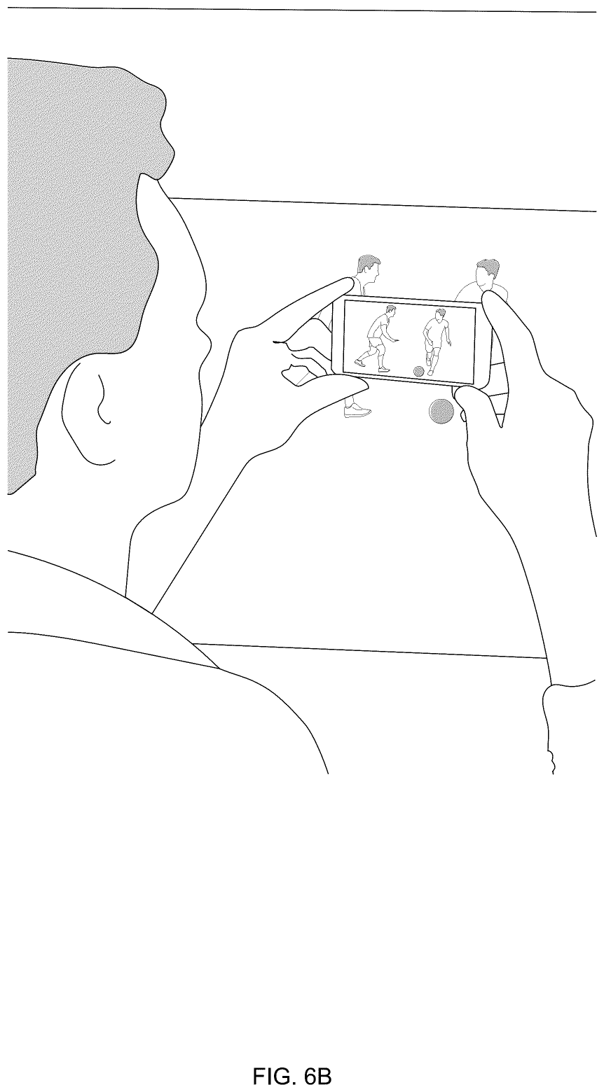

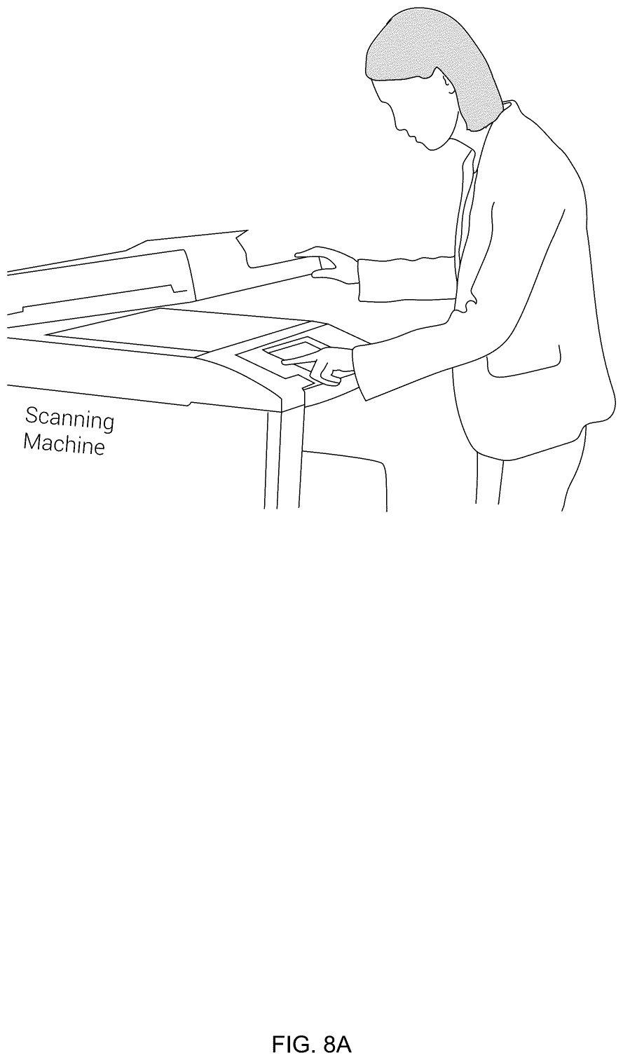

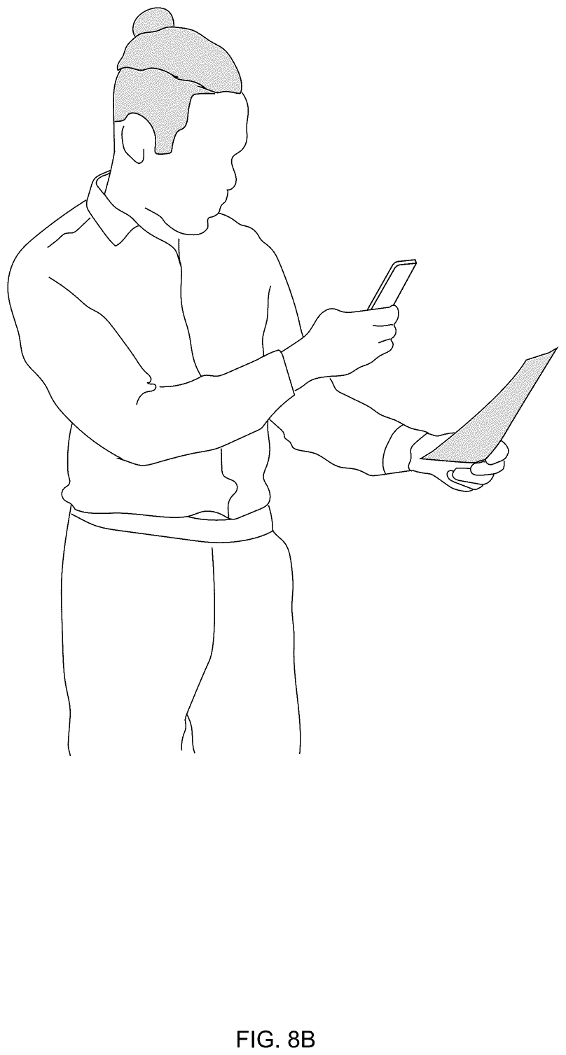

FIGS. 6A&B depict a collaborator acquiring photo media component of a tribute to an entity using a camera FIG. 6A and mobile phone FIG. 6B. The acquisition of images can also be accomplished using the image acquisition properties on a mobile phone FIG. 8B, or scanning devices that transform existing photographs or documents to the electronic equivalents (FIG. 8A)

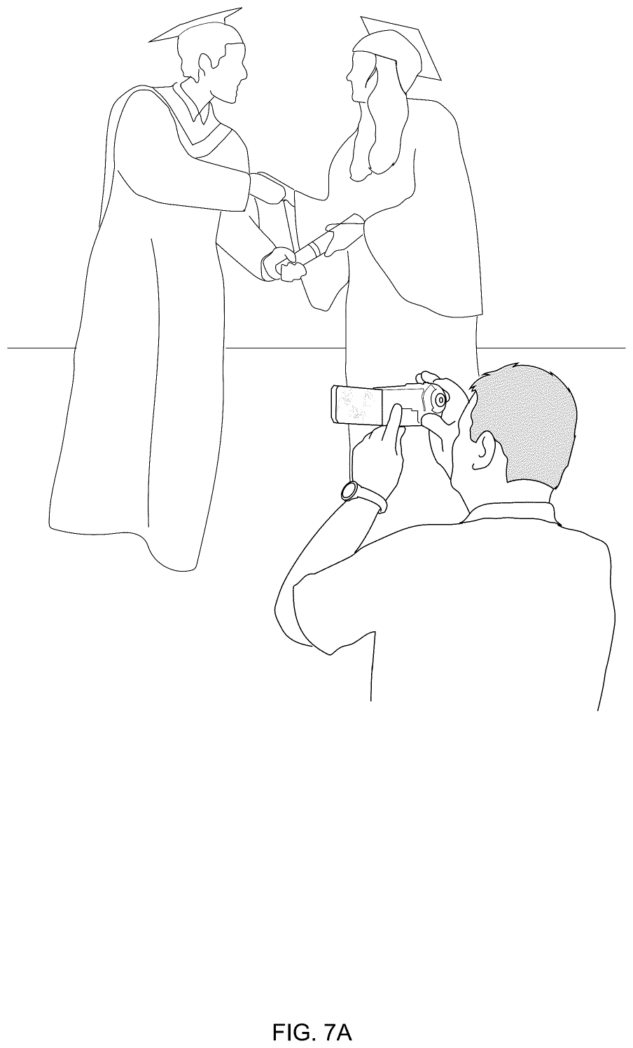

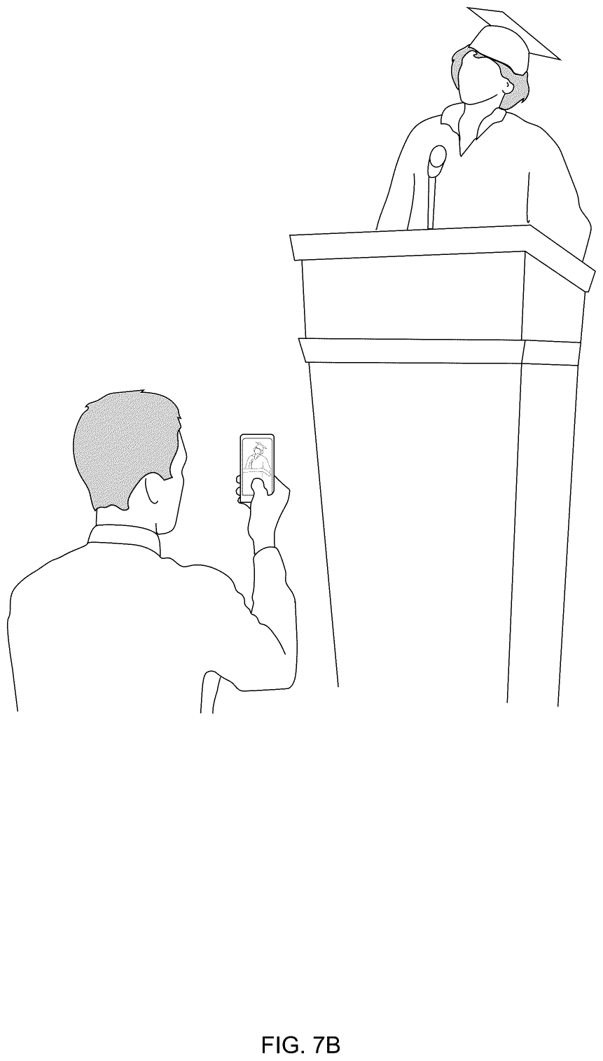

FIGS. 7A&7B depict a collaborator acquiring video media component of a tribute to an entity using a video camera or equivalent device with video capturing capabilities FIG. 7A and mobile phone FIG. 7B.

The media may be edited by the initiator and collaborators on the acquisition device prior to submission to the portal. Transmission of submitted media may occur through internet based upload protocols or as electronic mail attachments. Upon submission, the media are transmitted to the computer, internet or cloud based server. The administrator may be notified of new media submission. The administrator may approve new submissions prior to inclusion in the project.

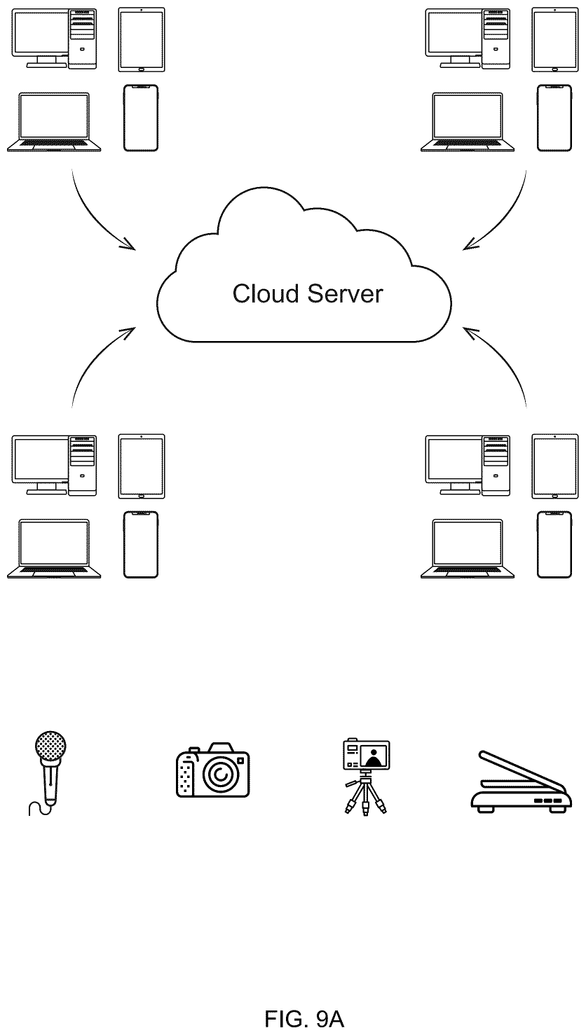

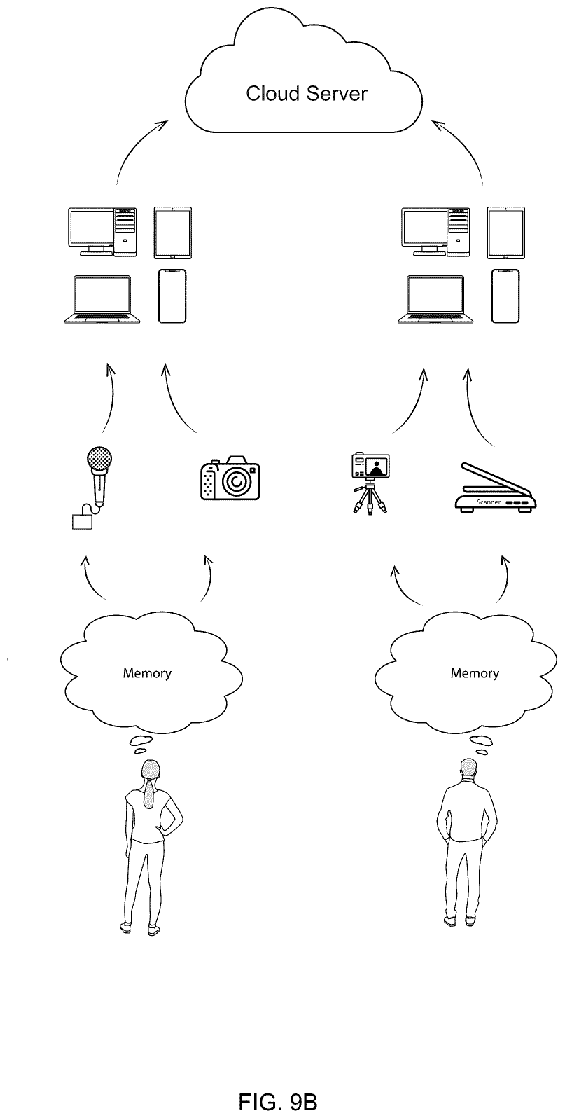

FIG. 9 depicts the transmission of the acquired media from media acquisition devices X, Y, Z, unto computer or mobile phone devices with capabilities to transfer the media to other computer or internet, cloud based servers.

The submitted media are sorted and stored according to attributes such as name of tribute, initiator, collaborator, administrator and time of submission. The administrator may approve submitted media prior to inclusion in the project. The initiator or administrator may self-designate or identify another person who will edit and curate the submitted media, herein termed the editor. The submitted, sorted and stored media can be downloaded by the initiator, administrator or assigned editor.

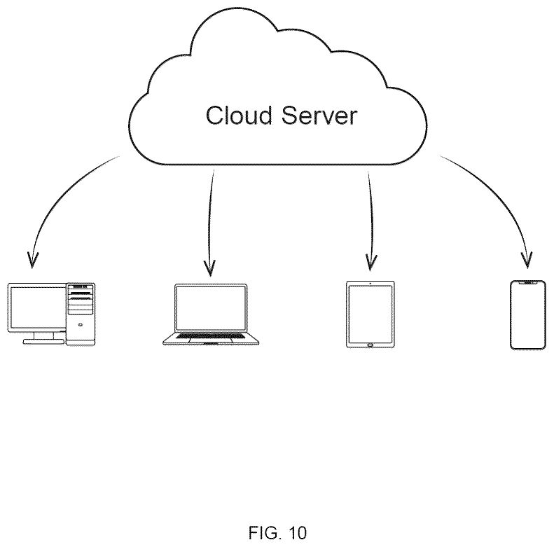

FIG. 10 depicts the process of downloading the sorted media to a computer or mobile phone based device with media editing capabilities.

The downloaded media are edited and curated to achieve a harmonized tribute to the entity. Editing may create transitions between the individual media submissions, labelling, juxtaposition of media components and harmony with regards to the central theme of the project.

The initiator, administrator or collaborators may approve the edited project prior to publishing. The initiator, administrator or collaborator may elect the mode of dissemination and target audience for the final project.

The project output may project may then be published or shared via text, audio, photo or video messages distributed via internet web based links, mobile phone or electronic mail messages or social media platforms, media storage devices, machine readable quick response or bar codes.

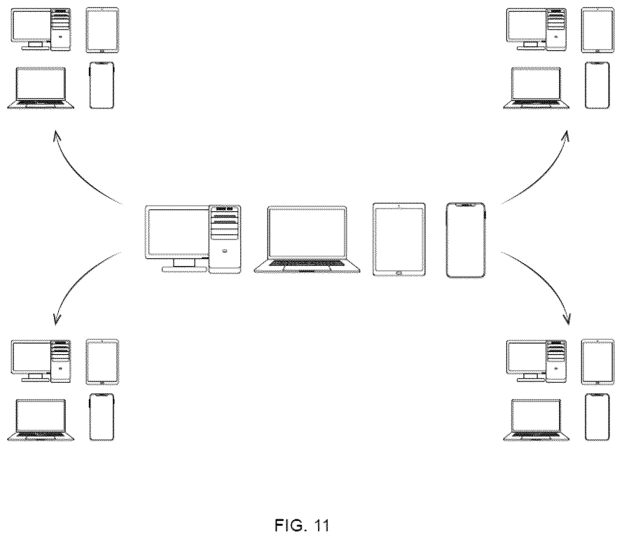

FIG. 11 depicts distribution of the tribute from the central computer or mobile phone to others.

The diagrams and illustrations above provide a comprehensive depiction of the embodiments of the present invention. However, alternate constructions and modifications are feasible. As such, the illustrations and descriptions above should not be interpreted as limiting the invention. The invention should be conferred with the broadest scope in tandem with the appended claims.

What is claimed is:

1. A method for initiating a text, audio, photo or video tribute, the method comprising:
Identifying the subject of the tribute, goal of the tribute and designating a name or label to the tribute
Establishing the criteria for the text, audio, photo or video inclusion in the tribute
Initiating the tribute using the user interface of a mobile phone or computer device
Inviting one or more individuals to contribute text, audio, photo or videos to the tribute;
Initiating a notification to one or more individuals to indicate that one or more individuals have been enabled to contribute to the tribute
Providing each contributing individual with the title, subject, goal and criteria for the tribute
Providing each contributing individual with the portal and directions for collaboration
Sending a notification to one or more individuals to indicate that one or more individuals have agreed, suggested a modification or declined to contribute to the tribute.

2. Method of claim 1 wherein the subject is a person, place or time; object, plant, animal, event or concept

3. Method of claim 1 wherein the goal of the tribute may describe aspects of the subject for which the tribute is being made

4. Method of claim 1 wherein the criteria may include type, number, size or volume and content of text, audio, photo or video to be included in the tribute.

5. Method of claim 1 where the mobile phone or computing device include mobile phone, computer tablet, laptop computer, desktop computer.

6. Method of claim 1 wherein the invited individual or individuals meet criteria based on their experience, knowledge or interest with the subject of the tribute.

7. Method of claim 1 wherein the invitation to collaborate is distributed via text, photo, audio or video messages disseminated via mobile phones, computer, internet links, electronic mail, social media, machine readable quick response or bar codes.

8. Method of claim 1 wherein the notification is transmitted as a text, photo, audio or video message via telephone network, internet, mobile phones, computer, internet links, electronic mail, social media, machine readable quick response or bar codes.

9. Method of claim 1 wherein the collaboration portal is a website or computer, mobile phone or social media based application

10. A method for acquiring and submitting text, audio, photo or video components of a tribute
Acquiring text, audio, photo or video with text, audio, photo or video capturing device by one or more individuals
Acquiring the text, audio, photo or video components of the tribute in conformity with the criteria set forth in claim 1
Acquiring the text, audio, photo or video components of the tribute in real time as one or more individuals interact with the subject of the tribute
Acquiring the text, audio, photo or video components of the tribute in retrospect as a recollection of the interaction between one or more individuals and the subject of the tribute.
One or more individuals editing the acquired text, audio, photo or video media on the acquisition or computing device to conform to criteria set forth in claim 1
Submitting the acquired text, audio, photo or video components of the tribute to the collaboration portal
Sending a notification to one or more individuals that a submission has been made
One or more individuals assessing the submitted text, audio, photo or video to ascertain conformity with the criteria defined in claim 1
Sending a notification to one or more individuals that a submitted text, audio, photo or video submission will be approved or denied inclusion in the tribute

11. Method of claim 10 wherein the image capturing device include computers in desktop, laptop or table configurations, mobile phones, audio recorders, cameras, photo or document scanners, video recorders in traditional, portable, wearable or miniaturized formats

12. A method for storage and retrieval of text, audio, photo and video components of a tribute
Transmitting submitted text, audio, photo and video via internet, telecommunication upload mechanisms
Sorting of submitted text, audio, photo and video media based on subject, name, time, type of text, audio, photo and video media
Storing sorted text, audio, photo and video in retrievable media formats in a computer, internet or cloud based server
One or more individuals retrieving stored text, audio, photo and video components of the tribute via internet, telecommunication upload mechanisms to a computer device

13. A system for editing submitted text, audio, photo and video components of a tribute
Notifying one or more individuals of the need to edit the text, audio, photo and video components of a tribute
Notifying one or more individuals of the goals of the tribute
One or more individuals editing text, audio, photo and video components of the tribute in conformity with the goals of the tribute
One or more individuals editing text, audio, photo and video components of the tribute using text, audio, photo and video editing software on a computing device
Notifying one or more individuals notified of the completion of editing of the tribute
One or more individuals assessing the edited tribute to ascertain conformity with the goal of the tribute defined in claim 1
One or more individuals approving the edited tribute
Transmitting the edited tribute via internet, telecommunication upload mechanisms
Storing the edited tribute in retrievable media formats in a computer, internet or cloud based server

14. Method of claim 13 wherein editing may include labelling, creating transitions and harmony or juxtaposing the text, audio, photo and video media submitted by one or more individuals.

15. A system for disseminating and publishing text, audio, photo and video tribute
Notifying one or more individuals of a completed tribute
One or more individuals defining the audience for the tribute
Disseminating the completed tribute from computer or cloud server to individual end users
Transmitting the tribute via mobile phones, computer, internet links, electronic mail, social media, machine readable quick response or bar codes
Transmitting the text, audio, photo and video tribute via internet, telecommunication download mechanisms

16. Method of claim 5 wherein one or more individual end users view the tribute using mobile phones or computers
